(19) United States
(12) Patent Application Publication
(10) Pub. No.: US 2023/0080464 A1
(43) Pub. Date: Mar. 16, 2023

(54) ASSEMBLING FILM, METHOD FOR ASSEMBLING DISPLAY, AND DISPLAY

(71) Applicant: HKC Corporation Limited, Shenzhen, Guangdong (CN)

(72) Inventors: Rong TANG, Shenzhen (CN); Jun NIE, Shenzhen (CN); Jianying ZHANG, Shenzhen (CN); Haoxuan ZHENG, Shenzhen (CN)

(73) Assignee: HKC Corporation Limited, Shenzhen, Guangdong (CN)

(21) Appl. No.: 17/801,837

(22) PCT Filed: Dec. 30, 2021
(86) PCT No.: PCT/CN2021/142999

§ 371 Date: Aug. 24, 2022

(30) Foreign Application Priority Data
Jan. 14, 2021 (CN) 202110048820.8

(51) Int. Cl. B32B 27/28; B32B 7/027; B32B 9/00; B32B 9/04; G02F 1/1335

(52) U.S. Cl. CPC B32B 27/283; B32B 7/027; B32B 9/007; B32B 9/045; G02F 1/133512

(57) ABSTRACT

An assembling film, a method for assembling a display, and a display are provided. The assembling film has a photothermal deformation effect. The assembling film includes: an organic material layer, and an inorganic material layer stacked together with the organic material layer. A thermal expansion coefficient of the organic material layer is different from a thermal expansion coefficient of the inorganic material layer. The assembling film in the double-layered structure formed by the organic material layer and the inorganic material layer has a particular photothermal deformation effect, and is able to be bent and deformed when being heated, and thus can be used to assemble the display, so as to tackle the light leakage problem and realize the light shielding effect.

This application claims the priority of a Chinese patent application with application number 202110048820.8 and titled “assembling film, method for assembling display, and display” filed with the China Patent Office on Jan. 14, 2021, the entire contents of which are incorporated herein by reference.

### TECHNICAL FIELD

The present application relates to the field of display material technology, and more particular to an assembling film, a method for assembling a display, and a display.

### BACKGROUND

Thin film transistor-liquid crystal display, also known as TFT-LCD, has become predominant in the display field, due to its low power consumption, excellent image quality, and relatively high production yield. TFT-LCD contains a display panel and a backlight module. The display panel includes: a color filter substrate (CF substrate); a thin film transistor array substrate (TFT substrate) arranged opposite to the CF substrate; and transparent electrodes arranged between an inner side of the CF substrate and an inner side of the TFT substrate. A layer of liquid crystal (LC) molecules is switched between the two substrates. The principle of the display panel is that the orientations of the LC molecules are controlled by the electric field to change a polarization state of the light, and the penetration and shielding of the light path is achieved by a polarizer, thereby achieving the displaying purpose.

With the improving requirement on the appearance of the display products, an entry borderless (EBL) technology design has become a mainstream in the market, however, such design has the problem of light leakage at the border. An existing technical solution is to enlarge the size of the CF substrate and to enable an edge of a black matrix (BM) to be aligned with an edge of the CF substrate, for the purpose of adopting the BM to shield the light leakage at the border and improving the user experience, however, such technique may result in excessive exposure of the BM, which in turn has the risk of electro-static discharge (ESD) and decreases the product performance.

### Technical Problems

It is an objective of embodiments of the present application to provide an assembling film, a method for assembling a display, and a display.

### Technical Solutions

Technical solutions adopted by embodiments of the present application are as follows:

In a first aspect, an assembling film is provided. The assembling film is configured for assembling a display. The assembling film has a photothermal deformation effect. The assembling film comprises: an organic material layer, and an inorganic material layer stacked together with the organic material layer. A thermal expansion coefficient of the organic material layer is different from a thermal expansion coefficient of the inorganic material layer.

In some embodiments, a ratio of the thermal expansion coefficient of the organic material layer to the thermal expansion coefficient of the inorganic material layer is 60-120:1.

In some embodiments, the thermal expansion coefficient of the organic material layer is between 200 and 600 ppm/° C.

In some embodiments, the thermal expansion coefficient of the inorganic material layer is between 5 and 30 ppm/° C.

In some embodiments, the organic material layer has a thickness of between 20 and 300 μm.

In some embodiments, the inorganic material layer has a thickness of between 1 and 20 μm.

In some embodiments, the inorganic material layer is made from a material comprises at least one selected from the group consisting of a carbon nanotube, a grapheme, a nano-alumina, a nano-titanium nitride, an amorphous carbon, an amorphous boron, and any combination thereof.

In some embodiments, the organic material layer is made from a material comprises at least one selected from the group consisting of a chitosan, a cellulose, a silicone rubber, a polysiloxane, a polytetrafluoroethylene, a polyvinylpyrrolidone, a polyvinylidene fluoride, a polydimethylsiloxane, and any combination thereof.

In a second aspect, a method for assembling a display is provided. The method for assembling the display comprises steps of:

providing an assembling film in a curved state; in which: the assembling film has a photothermal deformation effect; the assembling film comprises: an organic material layer, and an inorganic material layer stacked together with the organic material layer; and a thermal expansion coefficient of the organic material layer is different from a thermal expansion coefficient of the inorganic material layer; and

adhering the assembling film in the curved state to a back surface of a display panel at an end of the display panel adjacent to an outer frame, illuminating the assembling film by a backlight to make the assembling film in a flat state, whereby shielding a light leakage area between the display panel and the outer frame;

In some embodiments, a ratio of the thermal expansion coefficient of the organic material layer to the thermal expansion coefficient of the inorganic material layer is 60-120:1.

In some embodiments, the thermal expansion coefficient of the organic material layer is between 200 and 600 ppm/° C.

In some embodiments, the thermal expansion coefficient of the inorganic material layer is between 5 and 30 ppm/° C.

In some embodiments, the organic material layer has a thickness of between 20 and 300 μm.

In some embodiments, the inorganic material layer has a thickness of between 1 and 20 μm.

In some embodiments, the inorganic material layer is made from a material comprises at least one selected from the group consisting of a carbon nanotube, a grapheme, a nano-alumina, a nano-titanium nitride, an amorphous carbon, an amorphous boron, and any combination thereof.

In some embodiments, the inorganic material layer is made from a material comprises at least one selected from the group consisting of a carbon nanotube, a grapheme, a nano-alumina, a nano-titanium nitride, an amorphous carbon, an amorphous boron, and any combination thereof.

In some embodiments, the light leakage area is a light leakage area without being covered by a black matrix.

In some embodiments, the display panel comprises: a color film substrate, and an array substrate arranged opposite to the color film substrate. The step of adhering the assembling film in the curved state to the back surface of the display panel at the end of the display panel adjacent to the outer frame comprises: adhering a side of the assembling film where the organic material layer is located to a back surface of the array substrate.

In some embodiments, the display panel comprises: a color film substrate, and an array substrate arranged opposite to the color film substrate. The step of adhering the assembling film in the curved state to the back surface of the display panel at the end of the display panel adjacent to the outer frame comprises: adhering a side of the assembling film where the inorganic material layer is located to a back surface of the array substrate, and enabling an end of the organic material layer to be exposed, so as to be adhered to the back surface of the array substrate.

In a third aspect, a display is provided. The display comprises a display panel and an outer frame. The he display panel comprises: a color film substrate, and an array substrate, which is arranged opposite to the color film substrate. An assembling film is arranged between a back surface of the array substrate and the outer frame and configured to shield a light leakage area without being covered by a black matrix. The assembling film has a photothermal deformation effect, and comprises: an organic material layer, and an inorganic material layer stacked together with the organic material layer. A thermal expansion coefficient of the organic material layer is different from a thermal expansion coefficient of the inorganic material layer. A ratio of the thermal expansion coefficient of the organic material layer to the thermal expansion coefficient of the inorganic material layer is 60-120:1. The organic material layer has a thickness of between 20 and 300 μm. The inorganic material layer has a thickness of between 1 and 20 μm.

### Beneficial Effects

Advantages of the assembling film provided by embodiments of the present application are summarized as follows: the assembling film comprises the organic material layer and the inorganic material layer stacked together with the organic material layer. The assembling film in the double-layered structure formed by the organic material layer and the inorganic material layer has a particular photothermal deformation effect, and is able to convert a light energy into a thermal energy in case of light illumination. Because the thermal expansion coefficient of the organic material layer is different from the thermal expansion coefficient of the inorganic material layer, the double-layered film can be bent and deformed when being heated, and thus can be used to assemble the display, so as to tackle the light leakage problem and realize the light shielding effect.

Advantages of the method for assembling a display provided by embodiments of the present application are summarized as follows: the assembling method adopts the particular assembling film for assembling. In particular, the assembling film in the curved state is adhered to the back surface of the display panel at an end of the display panel adjacent to the outer frame, and the assembling film is illuminated by a backlight. Due that the assembling film has a particular photothermal deformation effect, and is able to convert a light energy into a thermal energy in case of light illumination, as well as be deformed to be a flat state under heating, in this way, the light leakage area between the display panel and the outer frame can be effectively shielded, thereby solving the light leakage problem and realizing the light shielding effect.

Advantages of the display provided by embodiments of the present application are summarized as follows: an assembling film is arranged between a back surface of the array substrate and the outer frame of the display and is configured to shield a light leakage area without being covered by a black matrix. The assembling film is a double-layered assembling film formed by the organic material layer and the inorganic material layer, and has a particular photothermal deformation effect, therefore can be applied in the display to tackle the light leakage problem and realize the light shielding effect.

### BRIEF DESCRIPTION OF THE DRAWINGS

In order to more clearly illustrate the technical solutions in the embodiments of the present application, the drawings that need to be used in the description of the embodiments or the exemplary technology will be briefly described hereinbelow. Obviously, the accompanying drawings in the following description are only some embodiments of the present application. For those skilled in the art, other drawings can be obtained based on these drawings without creative work.

FIG. 1 is a schematic structural diagram of an assembling film provided by an embodiment of the present application;

FIG. 2 is a flowchart of a method for assembling a display provided by an embodiment of the present application;

FIG. 3 is a schematic diagram showing an assembling film being applied in the assemblage and adhesion of the display provided by an embodiment of the present application;

FIG. 4 is a schematic diagram showing an assembling film being applied in the assemblage and adhesion of the display provided by an embodiment of the present application; and

FIG. 5 is a schematic diagram showing an assembling film being applied in the assemblage and adhesion of the display provided by an embodiment of the present application.

In the drawings, the following reference numerals are adopted:

1: Assembling film; 11: Organic material layer; 12: Inorganic material layer; 2: Display panel; 21: Array substrate; 22: Color film substrate; and 3: Outer frame.

### DETAILED DESCRIPTION OF EMBODIMENTS

In order to make the purposes, technical solutions, and advantages of the present application clearer and more understandable, the present application will be further described in detail hereinafter with reference to the accompanying drawings and embodiments. It should be understood that the embodiments described herein are only intended to illustrate but not to limit the present application.

In the present application, “at least one” refers to one or more, and “multiple” refers to two or more. “At least one of item(s)” or similar expressions refer to any combination of these items, including any combination of single item(s) or plural items(s).

It should be understood that, in various embodiments of the present application, the size of the sequence numbers of the above-mentioned processes does not imply the sequence of execution, some or all of the steps may be executed in parallel or sequentially, and the execution sequence of each process should be based on the function and internal logic thereof, but should not constitute any limitation on the implementation process of the embodiments of the present application.

The terms used in the embodiments of the present application are only for the purpose of describing specific embodiments, and are not intended to limit the present application. As used in the embodiments of the present application and the appended claims, the singular forms “a”, “the”, and “said” are intended to include the plural forms as well, unless otherwise clearly indicated in the context.

Technical solutions provided in the present application are explained in details in conjunction with the specific drawings and embodiments.

Embodiments of the present application provide an assembling film. The assembling film is configured for assembling a display. The assembling film has a photothermal deformation effect. As shown in FIG. 1, the assembling film comprises: an organic material layer 11, and an inorganic material layer 12 stacked together with the organic material layer 11. A thermal expansion coefficient of the organic material layer 11 is different from a thermal expansion coefficient of the inorganic material layer 12.

The assembling film provided by embodiments of the present application is a new assembling material film for mechanisms, such new assembling material film comprises the organic material layer 11 and the inorganic material layer 12 stacked together with the organic material layer 11. The assembling film in the double-layered structure formed by the organic material layer 11 and the inorganic material layer 12 has a particular photothermal deformation effect, and is able to convert a light energy into a thermal energy in case of light illumination. Because the thermal expansion coefficient of the organic material layer is different from the thermal expansion coefficient of the inorganic material layer, the double-layered film can be bent and deformed when being heated, and therefore can be used to assemble the display, so as to tackle the light leakage problem and realize the light shielding effect.

In some embodiments, the assembling film is made from a material comprising an organic material and an inorganic material. The organic material forms the organic material layer 11, and the inorganic material forms the inorganic material layer 12. The inorganic material in the inorganic material layer 12 is a photothermal material, which comprises, for example, at least one selected from the group consisting of a carbon nanotube, a grapheme, a nano-alumina, a nano-titanium nitride, an amorphous carbon, an amorphous boron, and any combination thereof, as well as a photothermal material having a plasma enhancement effect. The organic material in the organic material layer 11 is an organic polymer having good flexibility and a large thermal expansion coefficient, such as an organic flexible material used for a photo-actuated composite film, such an organic polymer having a carbon chain has a matching group that can chemically bond with hydroxyl and carboxyl groups. In particular, the organic material can be at least one selected from the group consisting of a chitosan, a cellulose, a silicone rubber, a polysiloxane, a polytetrafluoroethylene, a polyvinylpyrrolidone (PVP), a polyvinylidene fluoride (PVDF), a polydimethylsiloxane (PDMS), and any combination thereof.

In some embodiments, a ratio of the thermal expansion coefficient of the organic material layer 11 to the thermal expansion coefficient of the inorganic material layer 12 is 60-120:1. The greater the difference between the thermal expansion coefficient of the organic material layer 11 and the thermal expansion coefficient of the inorganic material layer 12 is, the more easily bendable the assembling film is. In particular, the thermal expansion coefficient of the organic material layer 11 is between 200 and 600 ppm/° C. The thermal expansion coefficient of the inorganic material layer 12 is between 5 and 30 ppm/° C. In this way, the assembling film featured in such combination of thermal expansion coefficients can be better used to assemble the display for light shield.

In some embodiments, the organic material layer 11 has a thickness of between 20 and 300 μm. The inorganic material layer 12 has a thickness of between 1 and 20 μm. The above thickness ranges not only enable the assembling film to be better bent, but also realize better light shielding.

In some embodiments, the assembling film is made by a coating process. In particular, the double-layered film is obtained by coating. Taking the assembling film in a double-layered structure of PDMS/grapheme as an example, a main agent and a curing agent of PDMS are mixed in a mass ratio of 10:1, and a resulting solution is coated by way of spin-coating or extruded coating. Thereafter, a resulting coating is put in an oven at between 40 and 100° C., and cured for between 2 and 4 hrs to form a PDMS layer. After that, a graphene solution having a concentration of between 10 and 200 mg/ml is coated, then a resulting intermediate product is cured for between 2.5 and 5 hrs at a temperature of between 40 and 100° C., to form a graphene layer. In this way, an assembled film in the double-layered structure of PDMS/the grapheme is finally obtained.

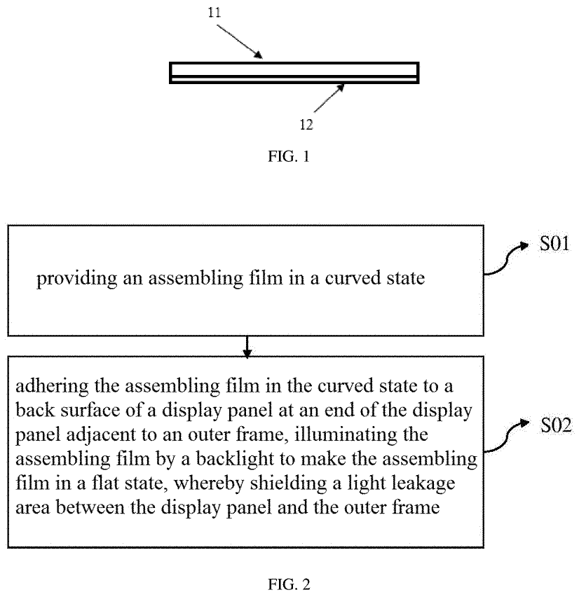

Some embodiments of the present application further provide a method for assembling a display. As shown in FIG. 2, the assembling method comprises steps S01 and S02.

In step S01, an assembling film in a curved state is provided.

In step S02, the assembling film in the curved state is adhered to a back surface of a display panel at an end of the display panel adjacent to an outer frame, the assembling film is then illuminated by a backlight to make the assembling film in a flat state, such that a light leakage area between the display panel and the outer frame is shielded.

The assembling film has a photothermal deformation effect. As shown in FIG. 1, the assembling film comprises: an organic material layer 11, and an inorganic material layer 12 stacked together with the organic material layer 11. A thermal expansion coefficient of the organic material layer 11 is different from a thermal expansion coefficient of the inorganic material layer 12.

The assembling method for the display provided by embodiments of the present application adopts the particular assembling film for assembling. In particular, due to the particular photothermal deformation effect, the assembling film is able to convert a light energy into a thermal energy in case of light illumination. Because the thermal expansion coefficient of the organic material layer is different from the thermal expansion coefficient of the inorganic material layer, the assembling film can be bent and deformed when being heated. In view of this, the assembling film in the curved state is adhered to the back surface of the display panel at an end of the display panel adjacent to the outer frame, and the assembling film is illuminated by a backlight. Due that the assembling film has the particular photothermal deformation effect, and is able to convert the light energy into the thermal energy in case of light illumination, as well as be deformed to be a flat state under heating, in this way, the light leakage area between the display panel and the outer frame can be effectively shielded, thereby solving the light leakage problem and realizing the light shielding effect.

In some embodiments, in the above adopted assembling film, a ratio of the thermal expansion coefficient of the organic material layer 11 to the thermal expansion coefficient of the inorganic material layer 12 is 60-120:1. In particular, the thermal expansion coefficient of the organic material layer 11 is between 200 and 600 ppm/° C. The thermal expansion coefficient of the inorganic material layer 12 is between 5 and 30 ppm/° C. The organic material layer 11 has a thickness of between 20 and 300 μm. The inorganic material layer 12 has a thickness of between 1 and 20 μm. The inorganic material layer 12 is made from a material comprises at least one selected from the group consisting of a carbon nanotube, a grapheme, a nano-alumina, a nano-titanium nitride, an amorphous carbon, an amorphous boron, and any combination thereof. The organic material layer 11 is made from a material comprises at least one selected from the group consisting of a chitosan, a cellulose, a silicone rubber, a polysiloxane, a polytetrafluoroethylene, a polyvinylpyrrolidone, a polyvinylidene fluoride, a polydimethylsiloxane, and any combination thereof.

In particular, the display panel comprises: an array substrate (TFT substrate), and a color film (CF) substrate. In some embodiments of the present application, the assembling film and the TFT substrate can be adhered and assembled together by using an adhesive.

In some embodiments, the light leakage area is a light leakage area without being covered by a black matrix. This assembling method is able to improve the product performance as well as avoid the risk of the ESD by tackling the light leakage problem of the EBL design. The assembling film is prepared into a curved state in advance. After the assemblage of the mechanism is completed, under the illumination of a backlight source, the assembling film is automatically transformed from the curved state to a flat state, which shields the area of the back surface that is not covered by the BM, thus achieving the light shielding and the border design.

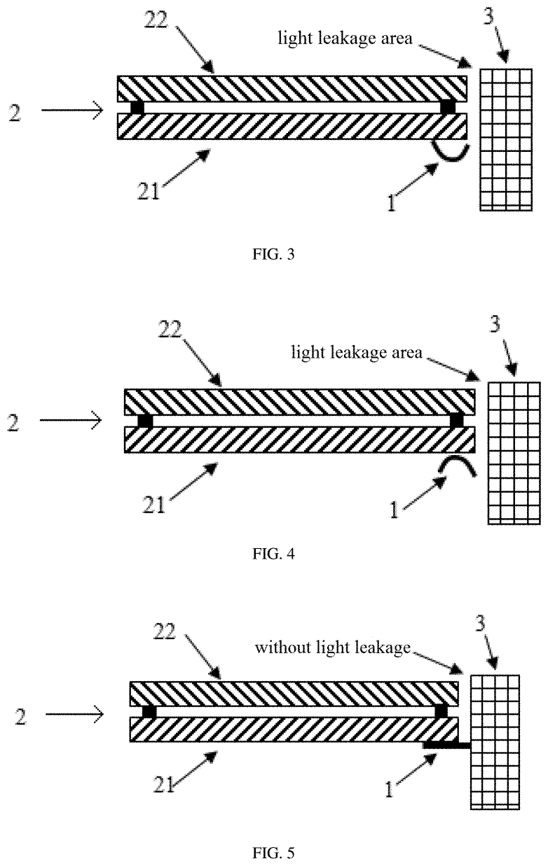

In some embodiments, as shown in FIG. 3, the display panel 2 comprises: a color film substrate 22, and an array substrate 21 arranged opposite to the color film substrate 22. The step of adhering the assembling film 1 in the curved state to the back surface of the display panel 2 at the end of the display panel 2 adjacent to the outer frame 3 comprises: adhering a side of the assembling film 1 where the organic material layer 11 is located to a back surface of the array substrate 21. As shown in FIGS. 1 and 3, since the thermal expansion coefficient of the organic material layer 11 in the assembling film 1 is greater, the bending amplitude is larger, so that one side of the assembling film where the organic material layer 11 is located is adhered to a back surface of the array substrate 21 (that is, the organic material layer 11 is upward). Then, as shown in FIG. 5, the assembling film is illuminated by a backlight source and converted into a flat state, such that the light leakage area between the display panel 2 and the outer frame 3 is shielded, and thus effectively avoiding the light leakage phenomenon.

In some embodiments, as shown in FIG. 4, the display panel 2 comprises: a color film substrate 22, and an array substrate 21 arranged opposite to the color film substrate 22. The step of adhering the assembling film 1 in the curved state to the back surface of the display panel 2 at the end of the display panel 2 adjacent to the outer frame 3 comprises: adhering a side of the assembling film 1 where the inorganic material layer 12 is located to a back surface of the array substrate 21, and enabling an end of the organic material layer 11 to be exposed, so as to be adhered to the back surface of the array substrate 21. As shown in FIGS. 1 and 4, since the thermal expansion coefficient of the organic material layer 11 in the assembling film 1 is greater, the bending amplitude is larger, so that one side of the assembling film where the inorganic material layer 12 is located is adhered to a back surface of the array substrate 21 (that is, the inorganic material layer 12 is upward). Then, as shown in FIG. 5, the assembling film is illuminated by a backlight source and converted into a flat state, such that the light leakage area between the display panel 2 and the outer frame 3 is shielded, and thus effectively avoiding the light leakage phenomenon. In order to enhance the adhesion, an end of the organic material layer 11 is exposed to be adhered to the back surface of the array substrate 21. By making the end of the organic material layer 11 of the assembling film 1 that is in contact with the assembling film 1 exposed, the end of the organic material layer 11 is then adhered to the array substrate 21, in this way, the adhesion of the assembled film 1 is further improved.

Embodiments of the present application further provide a display. As shown in FIG. 5, the display comprises: a display panel 2 and an outer frame 3. The display panel 1 comprises: a color film substrate 22, and an array substrate 21, which is arranged opposite to the color film substrate 22. An assembling film 1 is arranged between a back surface of the array substrate 21 and the outer frame 3, and is configured to shield a light leakage area that is not covered by a black matrix. The assembling film has a photothermal deformation effect. The assembling film comprises: an organic material layer 11, and an inorganic material layer 12 stacked together with the inorganic material layer 11 (that is, either the organic material layer 11 or the inorganic material layer 12 can be adhered to the back surface of the array substrate 12). A thermal expansion coefficient of the organic material layer 11 is different from a thermal expansion coefficient of the inorganic material layer 12. A ratio of the thermal expansion coefficient of the organic material layer 11 to the thermal expansion coefficient of the inorganic material layer 12 is 60-120:1. The organic material layer 11 has a thickness of between 20 and 300 μm. The inorganic material layer 12 has a thickness of between 1 and 20 μm.

In particular, the outer frame 3 is an overall outer frame of the display.

In the display provided by embodiments of the present application, an assembling film 1 is arranged between a back surface of the array substrate 21 and the outer frame 3 of the display and is configured to shield a light leakage area without being covered by a black matrix. The assembling film 1 is a double-layered assembling film formed by the organic material layer 11 and the inorganic material layer 12, and has a particular photothermal deformation effect, thus being able to convert a light energy into a thermal energy in case of light illumination. Because the thermal expansion coefficient of the organic material layer 12 is different from the thermal expansion coefficient of the inorganic material layer 11, the double-layered film can be bent and deformed when being heated, and thus can be used to assemble the display, so as to tackle the light leakage problem and realize the light shielding effect. Within the above thermal expansion coefficient ratio and thickness range, the double-layered assembling film formed by the organic material layer 11 and the inorganic material layer 12 can achieve a best shielding effect of the light leakage area that is not covered by the black matrix in the display.

Embodiments of the present application provide a new assembling material film for mechanisms for the purpose of solving the light leakage problem of the EBL design. The assembling film is an assembling film in a double-layered structure formed by the organic material layer and the inorganic material layer. The assembling film in the double-layered structure formed by the organic material layer and the inorganic material layer has a particular photothermal deformation effect, and is able to convert a light energy into a thermal energy in case of light illumination. Because the thermal expansion coefficient of the organic material layer is greatly different from the thermal expansion coefficient of the inorganic material layer, the double-layered film can be bent and deformed when being heated, and therefore can be used to realize the light shielding effect and improve the light leakage.

The following description will be given in conjunction with specific examples.

### Example 1

A display, as shown in FIG. 5, includes a display panel 2 and an outer frame 3. The display panel 1 includes a color filter substrate 22 and an array substrate 21 arranged opposite to the color filter substrate 22. The assembling process is performed as follows:

A assembling film 1 in a curved state is provided. The assembling film 1 comprises: a graphene layer, and a polysiloxane layer stacked together with the grapheme layer.

A side of the curved assembling film where the polysiloxane layer is located is adhered to a back surface of the array substrate 21 at an end of the array substrate 21 adjacent to the outer frame 3 (as shown in FIG. 3). Thereafter, the assembling film 1 is illuminated by a backlight to make the assembling film 1 in a flat state, so as to shield a light leakage area between the display panel 1 and the outer frame 3 (as shown in FIG. 5).

### Example 2

A display, as shown in FIG. 5, includes a display panel 2 and an outer frame 3. The display panel 1 includes a color filter substrate 22 and an array substrate 21 arranged opposite to the color filter substrate 22. The assembling process is performed as follows:

A assembling film 1 in a curved state is provided. The assembling film 1 comprises: a graphene layer, and a polysiloxane layer stacked together with the grapheme layer.

A side of the curved assembling film where the graphene layer is located is adhered to a back surface of the array substrate 21 at an end of the array substrate 21 adjacent to the outer frame 3 (as shown in FIG. 4). Thereafter, the assembling film 1 is illuminated by a backlight to make the assembling film 1 in a flat state, so as to shield a light leakage area between the display panel 1 and the outer frame 3 (as shown in FIG. 5).

The aforementioned embodiments are only optional embodiments of the present application, and are not intended to limit the present application. It should be understood by those skilled in the art that various changes and modifications can be made to the present application. Any modification, equivalent replacement, improvement, and so on, which are made within the spirit and the principle of the present application, should be included in the protection scope of the present application.

1. An assembling film, configured for assembling a display, and having a photothermal deformation effect, the assembling film comprising:
an organic material layer, and
an inorganic material layer stacked together with the organic material layer;
wherein
a thermal expansion coefficient of the organic material layer is different from a thermal expansion coefficient of the inorganic material layer.

2. The assembling film according to claim 1, wherein a ratio of the thermal expansion coefficient of the organic material layer to the thermal expansion coefficient of the inorganic material layer is 60-120:1.

3. The assembling film according to claim 1, wherein the thermal expansion coefficient of the organic material layer is between 200 and 600 ppm/° C.

4. The assembling film according to claim 1, wherein the thermal expansion coefficient of the inorganic material layer is between 5 and 30 ppm/° C.

5. The assembling film according to claim 1, wherein the organic material layer has a thickness of between 20 and 300 μm.

6. The assembling film according to claim 1, wherein the inorganic material layer has a thickness of between 1 and 20 μm.

7. The assembling film according to claim 1, wherein the inorganic material layer is made from a material comprises at least one selected from the group consisting of a carbon nanotube, a grapheme, a nano-alumina, a nano-titanium nitride, an amorphous carbon, an amorphous boron, and any combination thereof.

8. The assembling film according to claim 1, wherein the organic material layer is made from a material comprises at least one selected from the group consisting of: a chitosan, a cellulose, a silicone rubber, a polysiloxane, a polytetrafluoroethylene, a polyvinylpyrrolidone, a polyvinylidene fluoride, a polydimethylsiloxane, and any combination thereof.

9. A method for assembling a display, comprising:
providing an assembling film in a curved state; and
adhering the assembling film in the curved state to a back surface of a display panel at an end of the display panel adjacent to an outer frame, illuminating the assembling film by a backlight to make the assembling film in a flat state, thereby shielding a light leakage area between the display panel and the outer frame;
wherein
the assembling film has a photothermal deformation effect;
the assembling film comprises: an organic material layer, and an inorganic material layer stacked together with the organic material layer; and
a thermal expansion coefficient of the organic material layer is different from a thermal expansion coefficient of the inorganic material layer.

10. The method for assembling a display of claim 9, wherein a ratio of the thermal expansion coefficient of the organic material layer to the thermal expansion coefficient of the inorganic material layer is 60-120:1.

11. The method for assembling a display of claim 9, wherein the thermal expansion coefficient of the organic material layer is between 200 and 600 ppm/° C.

12. The method for assembling a display of claim 9, wherein the thermal expansion coefficient of the inorganic material layer is between 5 and 30 ppm/° C.

13. The method for assembling a display of claim 9, wherein the organic material layer has a thickness of between 20 and 300 μm.

14. The method for assembling a display of claim 9, wherein the inorganic material layer has a thickness of between 1 and 20 μm.

15. The method for assembling a display of claim 9, wherein the inorganic material layer is made from a material comprises at least one selected from the group consisting of a carbon nanotube, a grapheme, a nano-alumina, a nano-titanium nitride, an amorphous carbon, an amorphous boron, and any combination thereof.

16. The method for assembling a display of claim 9, wherein the inorganic material layer is made from a material comprises at least one selected from the group consisting of a carbon nanotube, a grapheme, a nano-alumina, a nano-titanium nitride, an amorphous carbon, an amorphous boron, and any combination thereof.

17. The method for assembling a display of claim 9, wherein the light leakage area is a light leakage area without being covered by a black matrix.

18. The method for assembling a display of claim 9, wherein
the display panel comprises: a color film substrate, and an array substrate arranged opposite to the color film substrate; and
the step of adhering the assembling film in the curved state to the back surface of the display panel at the end of the display panel adjacent to the outer frame comprises: adhering a side of the assembling film where the organic material layer is located to a back surface of the array substrate.

19. The method for assembling a display of claim 9, wherein
the display panel comprises: a color film substrate, and an array substrate arranged opposite to the color film substrate; and
the adhering of the assembling film in the curved state to the back surface of the display panel at the end of the display panel adjacent to the outer frame comprises: adhering a side of the assembling film where the inorganic material layer is located to a back surface of the array substrate, and enabling an end of the organic material layer to be exposed, so as to be adhered to the back surface of the array substrate.

20. A display, comprising:
a display panel, the display panel comprising:
a color film substrate, and
an array substrate, which is arranged opposite to the color film substrate;
an outer frame; and
an assembling film, which is arranged between a back surface of the array substrate and the outer frame and configured to shield a light leakage area without being covered by a black matrix, has a photothermal deformation effect, and comprises:
an organic material layer, and
an inorganic material layer stacked together with the organic material layer;
wherein
a thermal expansion coefficient of the organic material layer is different from a thermal expansion coefficient of the inorganic material layer;
a ratio of the thermal expansion coefficient of the organic material layer to the thermal expansion coefficient of the inorganic material layer is 60-120:1;
the organic material layer has a thickness of between 20 and 300 μm; and
the inorganic material layer has a thickness of between 1 and 20 μm.
